(19) United States
(12) Patent Application Publication
(10) Pub. No.: US 2011/0132353 A1
(43) Pub. Date: Jun. 9, 2011

(54) TRANSPORTABLE MULTI-CONFIGURABLE SELF-BALLASTED MODULAR SOLAR POWER UNIT

(75) Inventors: Michael L. Gumm, Milpitas, CA (US); Daniel Jaeger, San Jose, CA (US)

(73) Assignee: SunPOD,S INC., San Jose, CA (US)

(21) Appl. No.: 12/961,276

(22) Filed: Dec. 6, 2010

Related U.S. Application Data
(60) Provisional application No. 61/283,556, filed on Dec. 4, 2009.

(51) Int. Cl. F24J 2/52; B23P 15/26

(52) U.S. Cl. 126/680; 29/890.033

(57) ABSTRACT

A transportable multi-configurable self-ballasted modular solar power unit has a support frame and a solar module frame hingedly connected to it. A plurality of solar modules are mounted on the solar module frame and a selected angle is chosen to increase the efficiency of the solar modules. Support arms are used to keep the solar module frame at the selected angle. Four trailer jacks are attached to the perimeter of the support frame and are used to raise and lower the unit. The unit is raised and set on a trailer or a wheel assembly is attached. The unit can then be transported to the selected installation site. Once at the site, the trailer jacks are raised until the trailer can be rolled out from under it. The trailer jacks can be adjusted individually if the surface is not level.

### CROSS REFERENCE TO RELATED APPLICATIONS

This application claims priority and herein incorporates by reference U.S. provisional patent application 61/283,556, filed Dec. 4, 2009.

### BACKGROUND OF THE INVENTION

It is clear that renewable energy sources are becoming more important to an overall energy plan as the cost of carbon based fuels continues to increase. Solar energy is an important component of a renewable plan. In order to produce usable energy from the sun, it is necessary to place solar modules in areas where they can capture solar radiation.

Conventional installations require considerable preparation before the solar modules can be installed and removal is about the same. This requires installers to spend time and effort at the installation site and increases both the cost and time of the installation. It is not practical to install large scale solar collectors on a temporary basis because of this.

There is a need for a pre-installed modular solar power unit that can be moved to the installation site with minimum preparation and can be easily removed.

### SUMMARY OF THE INVENTION

A transportable multi-configurable self-ballasted modular solar power unit has a support frame and a solar module frame hingedly connected to it. A plurality of solar modules are mounted on the solar module frame and a selected angle is chosen to increase the efficiency of the solar modules. Support arms are used to keep the solar module frame at the selected angle. Four trailer jacks are attached to the perimeter of the support frame and are used to raise and lower the unit. The unit is raised and set on a trailer or a wheel assembly is attached. The unit can then be transported to the selected installation site. Once at the site, the trailer jacks are raised until the trailer can be rolled out from under it. The trailer jacks can be adjusted individually if the surface is not level.

Other features and advantages of the instant invention will become apparent from the following description of the invention which refers to the accompanying drawings.

### BRIEF DESCRIPTION OF THE DRAWINGS

FIG. 1 is an end view of a transportable multi-configurable self-ballasted modular solar power unit according to an embodiment of the invention.

FIG. 2 is an end view of the transportable multi-configurable self-ballasted modular solar power unit shown in FIG. 1.

FIG. 3 is a top cutaway view of the transportable multi-configurable self-ballasted modular solar power unit shown in FIG. 1.

FIG. 4 is a perspective view of the transportable multi-configurable self-ballasted modular solar power unit shown in FIG. 12.

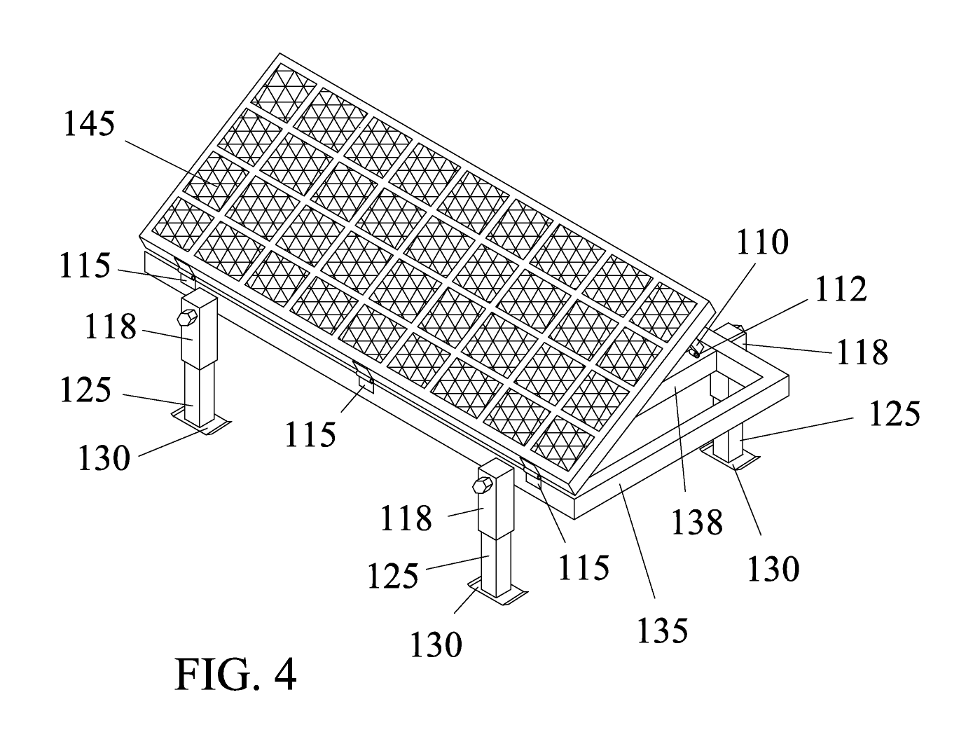

FIG. 5 is an end view of a transportable multi-configurable self-ballasted modular solar power unit according to an embodiment of the invention.

FIG. 6 is an end view of the transportable multi-configurable self-ballasted modular solar power unit shown in FIG. 5.

FIG. 7 is a side view of the transportable multi-configurable self-ballasted modular solar power unit shown in FIG. 12 mounted on a trailer.

FIG. 8 is a side view of the transportable multi-configurable self-ballasted modular solar power unit shown in FIG. 7 in a raised position.

FIG. 9 is a side view of two transportable multi-configurable self-ballasted modular solar power units connected together.

FIG. 10 is a side view of the transportable multi-configurable self-ballasted modular solar power unit shown in FIG. 12 with a wheel assembly fitted therein.

FIG. 11 is a side view of the transportable multi-configurable self-ballasted modular solar power unit shown in FIG. 1 installed on non-level surface.

FIG. 12 is a side view of the transportable multi-configurable self-ballasted modular solar power unit shown in FIG. 1 with an alternative trailer jack lifting mechanism.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

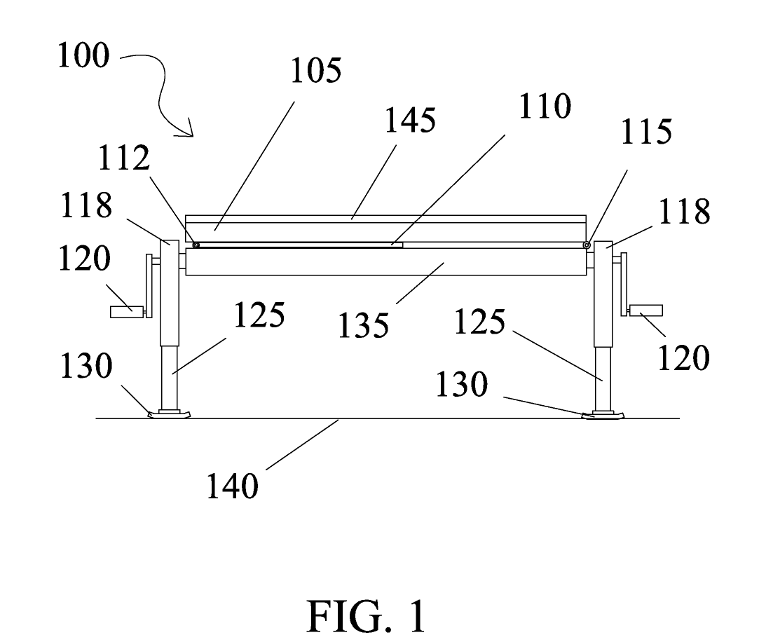

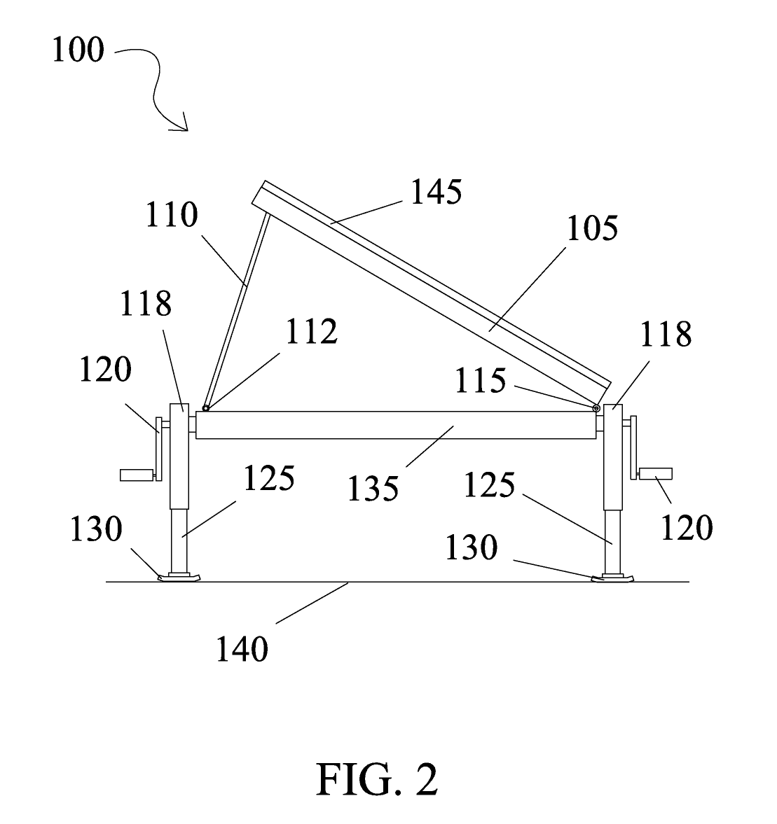

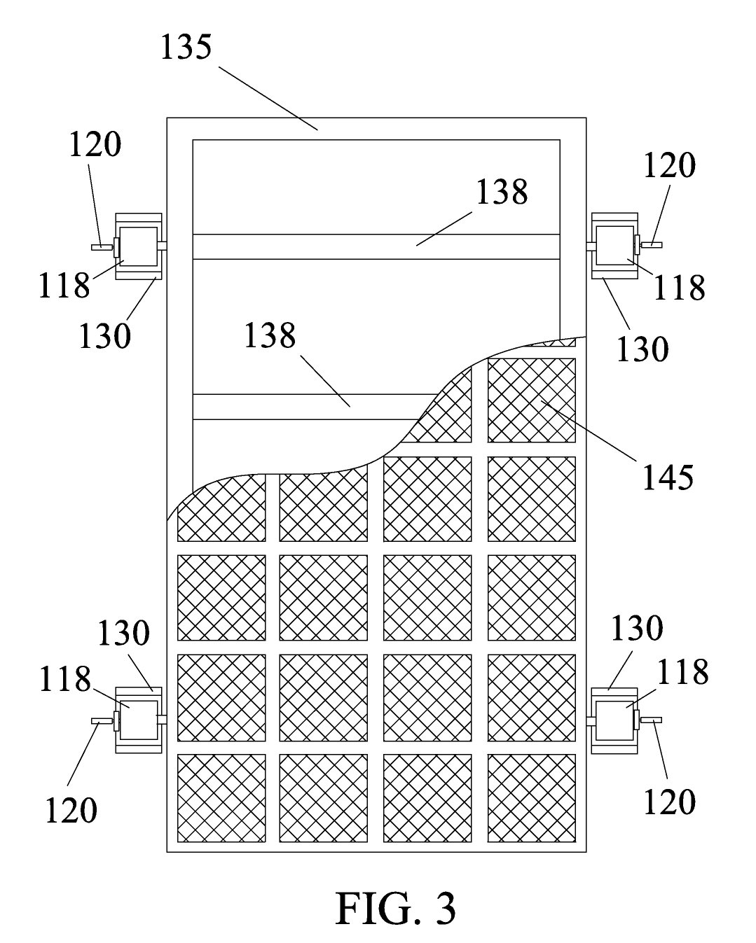

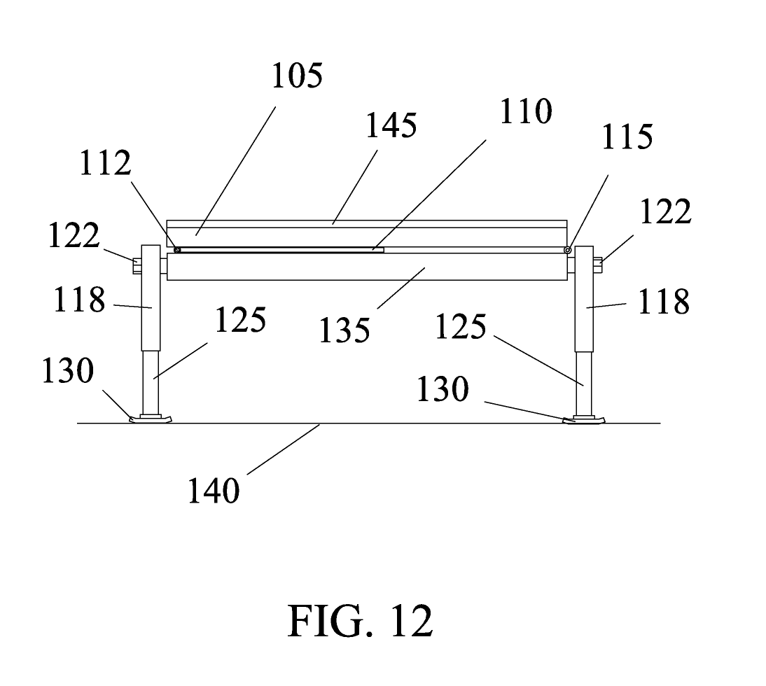

Referring to FIGS. 1 through 3, and 12, a transportable multi-configurable self-ballasted modular solar power unit 100 is shown having a support frame 135 with a plurality of joists 138 for structural support and rigidity. Four trailer jacks 118 are mounted to support frame 135 to support unit 100. Each trailer jack 118 has a telescoping leg 125 and a foot 130 which rests against a surface 140. Of course any number of trailer jacks may be used to increase stability, although in most situations three would be the minimum number of trailer jacks to provide a self-standing unit. A lifting mechanism 120 is used to raise and lower leg 125. As shown in FIG. 1, lifting mechanism 120 includes a hand crank to raise and lower foot 130. In FIG. 12, the hank crank is removed and replaced with a bolt 122. Bolt 122 is part of the lifting mechanism and a wrench or a powered wrench may be used to raise and lower foot 130. Of course other means may be used to raise and lower unit 100 such as electric servo driven screw, hydraulic lift, etc. as long as foot 130 is able to be raised and lowered to set unit 100 in place.

A plurality of solar modules 145 are mounted to a solar module frame 105. Solar module frame 145 also has joists (not shown) to add structural strength. Solar module frame 145 is hingedly attached to support frame 135 with hinges 115. Solar module frame 105 lies flat during transport and then is raised to the desired angle at the installation location. Support arms 110 are positioned to maintain the selected angle. Support arm 110 is hingedly connected to support frame 135 and is held in place with a retaining bracket (not shown). Of course support arm 110 may be welded or bolted in place to provide a permanently selected angle which may be desirable in some applications.

Support frame 135 and solar module frame 105 are made of galvanized steel. Of course other suitable materials such as aluminum, fiberglass, polymers and composite materials are examples of acceptable alternatives. The frames 135 and 105 are welded together, but they may also be bolted or riveted or a combination thereof.

Although in one embodiment, the installer can set the angle on site, it is also acceptable to set the angle at the factory and transport the unit in a preconfigured embodiment. Additionally, it is possible to add a motorized support arm 110 which can be controlled to track an optimal angle as the sun tracks during the day. The motor can be computer controlled to improve efficiency.

Additionally, in most situations, the weight of the unit is sufficient to keep it in place. This provides a self-ballasted unit that resists both wind forces as well as seismic force which is particularly important in earthquake prone regions. In some installations it may be desirable to provide additional support by using cabled impact or percussion driven earth anchors, earth nails or other suitable method to keep the unit in place in high wind conditions, areas of seismic activity or where required by local codes.

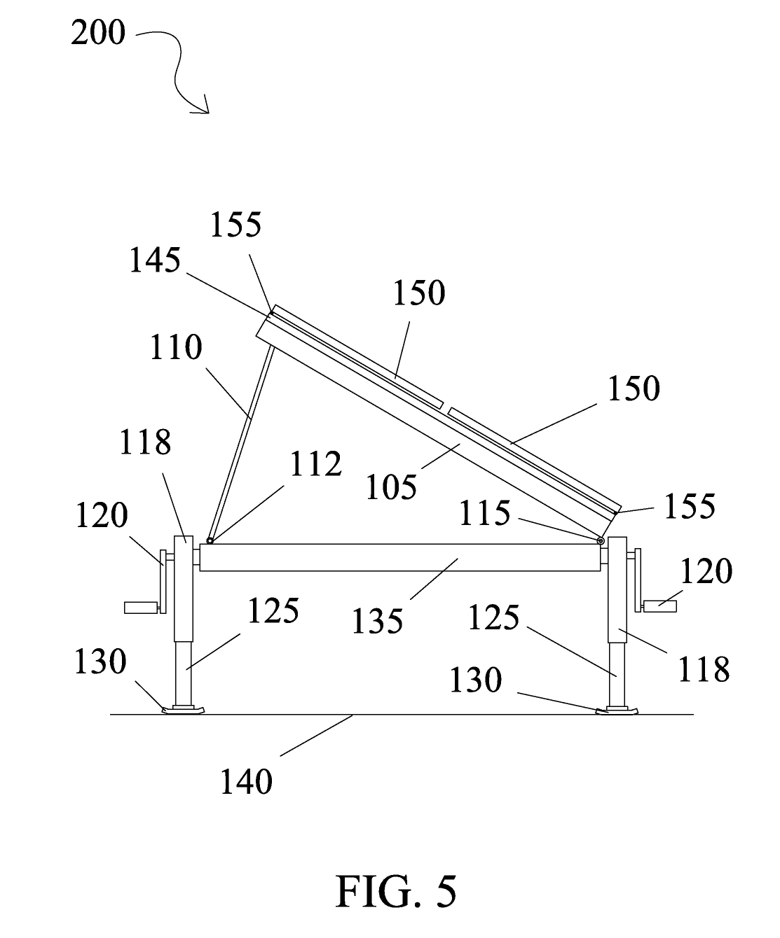

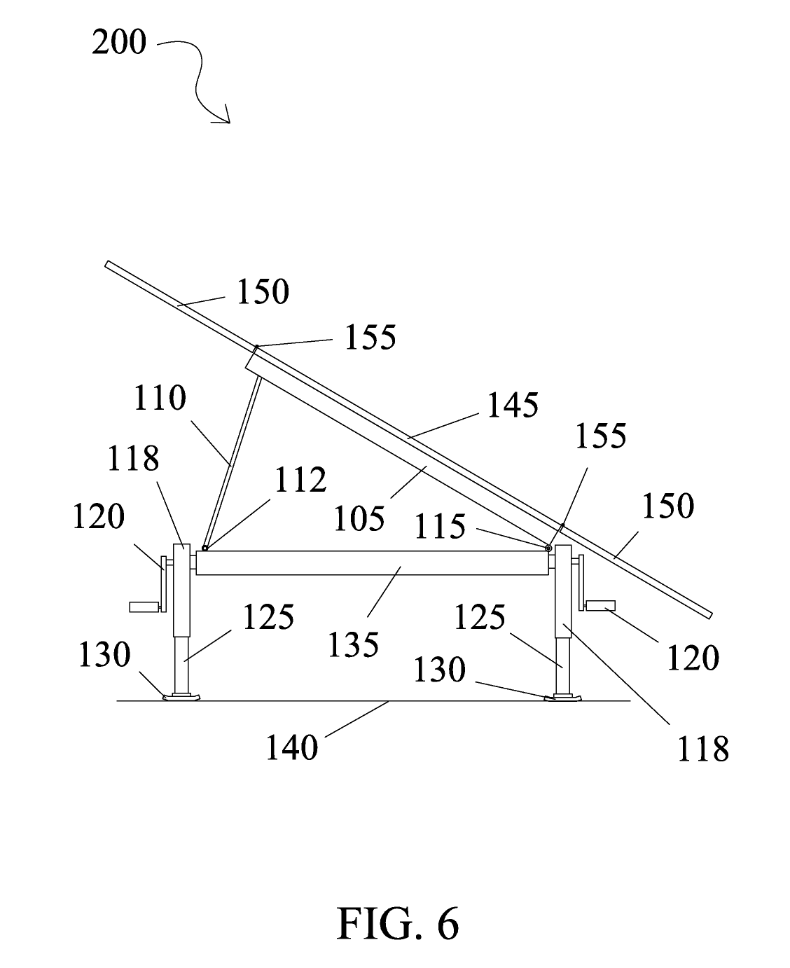

Referring now to FIGS. 5 and 6, an alternative embodiment of a transportable multi-configurable self-ballasted modular solar power unit 200 is shown having foldable solar modules 150 hingedly attached with solar module hinges 155. When opened (FIG. 6), the surface area of the electrical converting area is greatly increased thereby increasing output. Of course other configurations are possible such as folding along a long axis, multiple panels, etc. and are considered within the scope of this application.

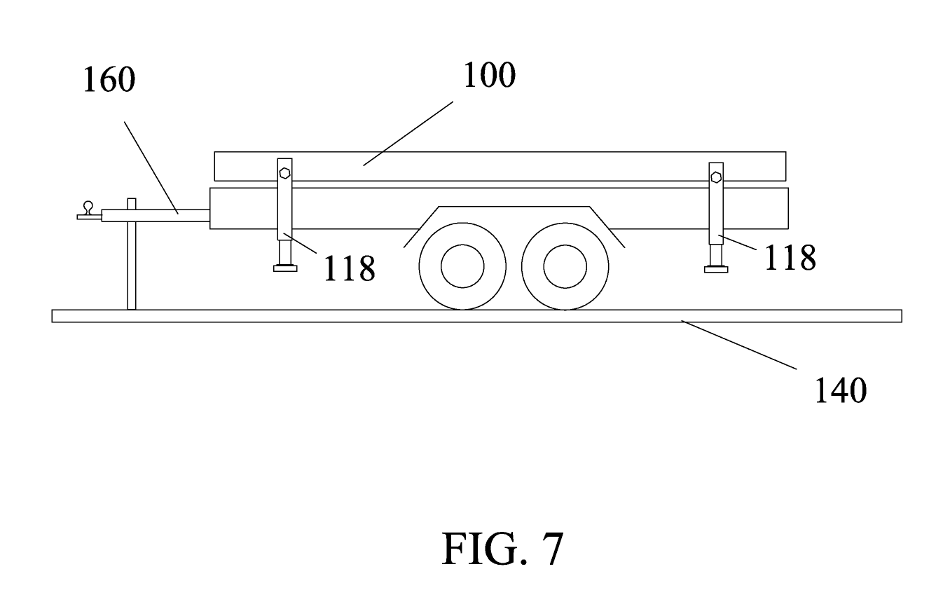

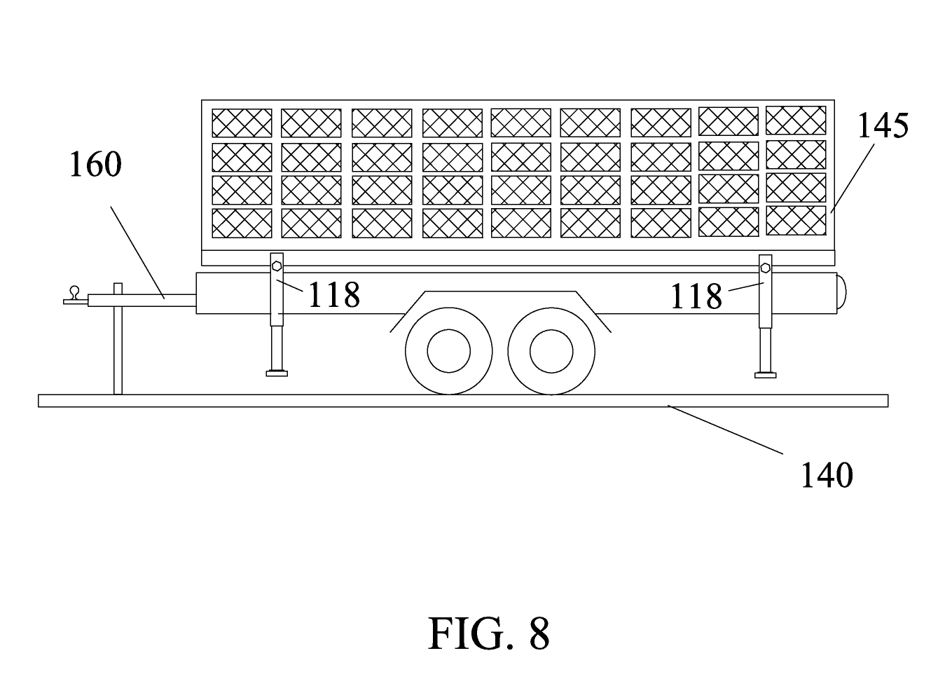

Referring now to FIGS. 7 and 8, transportable multi-configurable self-ballasted modular solar power unit 100 is shown mounted on a trailer 160 in both a flat transport configuration (FIG. 7) and an angled configuration (FIG. 8). In use, unit 100 is driven to selected installation site and trailer jacks 118 are lowered until unit 100 lifts off trailer 160. Once lifted, trailer 160 may be driven out from under to be used to transport another unit. To remove an installed unit, the process is reversed.

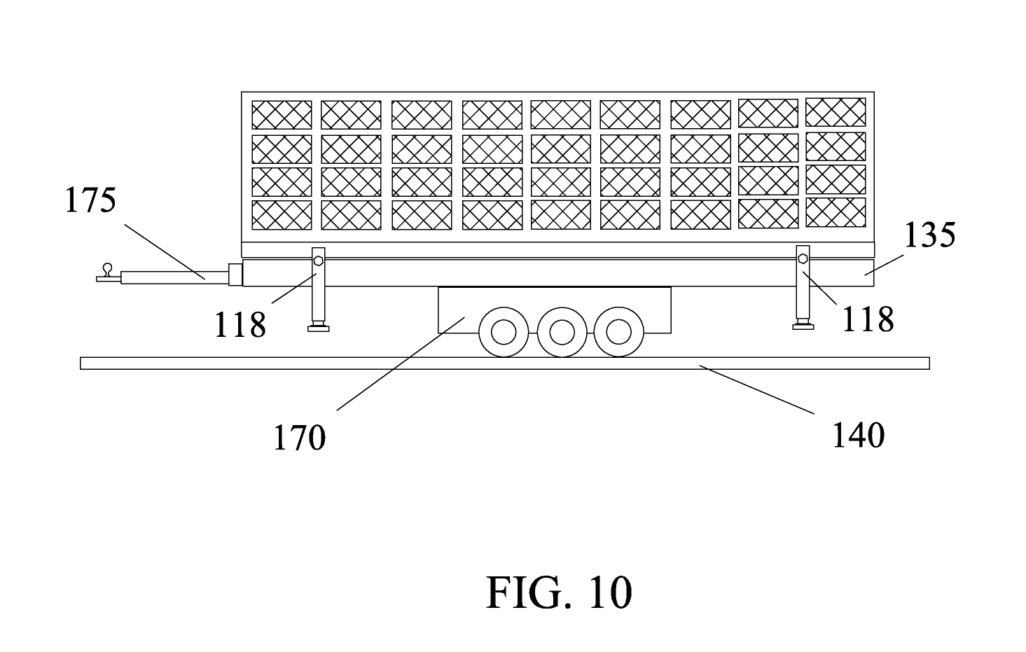

Referring to FIG. 10, unit 100 is supported using a wheel assembly that is attached to support frame 135, thus utilizing support frame 135 as a trailer when combined with a hitch assembly 175 also attached to support frame 135. Lighting and other road worthy requirements may be provided as is known in the art.

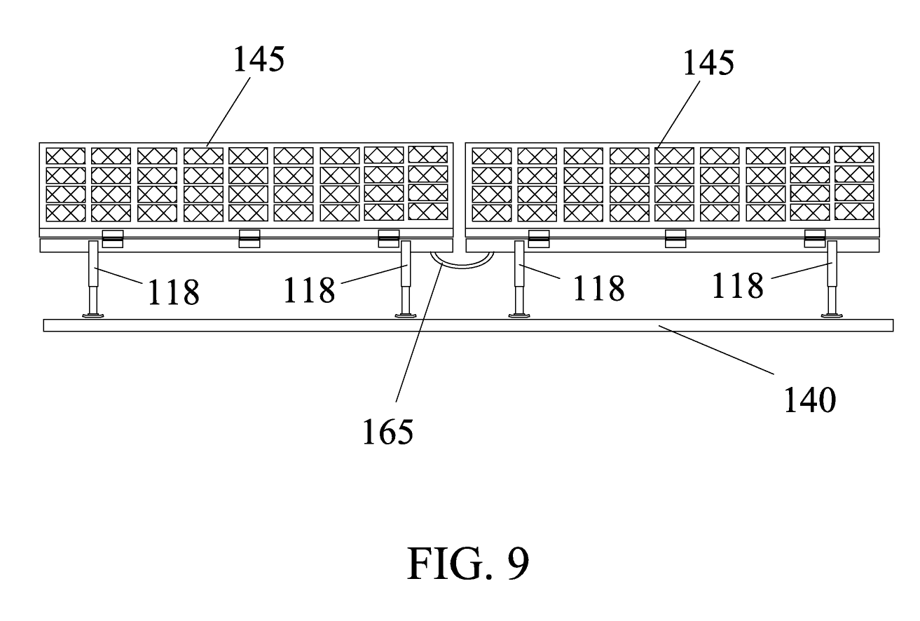

Now referring to FIG. 9, two transportable multi-configurable self-ballasted modular solar power units 100 are connected together to increase output. A connector 165 is used to electrically connect and transmit the energy collected. Although two units 100 are shown connected, any number of units may be joined together to match a selected use.

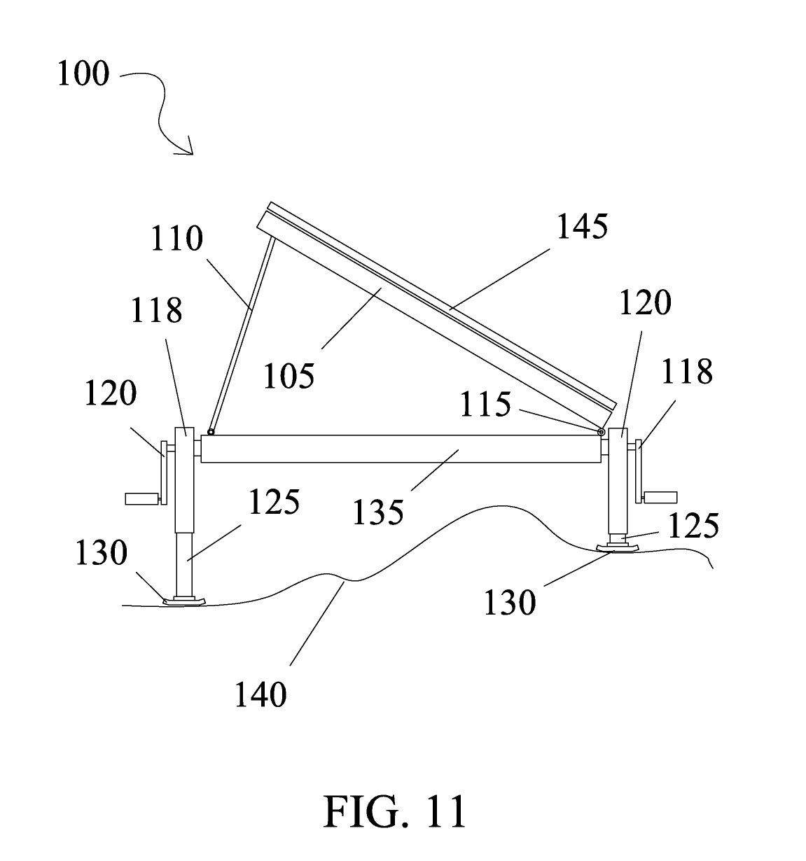

FIG. 11 illustrates setting unit 100 on an un-level surface. As can be seen, although the ground 140 is not level, trailer jacks 118 are individually positioned to make frame 135 level. This eliminates the need to level the surface prior to use.

Although the instant invention has been described in relation to particular embodiments thereof, many other variations and modifications and other uses will become apparent to those skilled in the art.

What is claimed is:

1. A transportable multi-configurable self-ballasted modular solar power unit comprises:
a support frame;
a solar module frame;
said solar module frame being attached to said support frame;
at least one solar module mounted on said solar module frame; and
a plurality of adjustable trailer jacks attached to a perimeter of said support frame.

2. The transportable multi-configurable self-ballasted modular solar power unit according to claim 1 wherein said solar module frame is hingedly attached to said support frame whereby said solar module support frame is adapted to be positioned at a selected angle.

3. The transportable multi-configurable self-ballasted modular solar power unit according to claim 2 further comprising a support arm hingedly attached to said support frame and adapted to hold said solar module support frame at said selected angle.

4. The transportable multi-configurable self-ballasted modular solar power unit according to claim 1 further comprising a wheel assembly mounted beneath said support frame whereby said support frame can be transported.

5. The transportable multi-configurable self-ballasted modular solar power unit according to claim 1 further comprising at least one foldable solar module portion hingedly attached to said at least one solar module whereby a larger collecting surface is provided when unfolded.

6. The transportable multi-configurable self-ballasted modular solar power unit according to claim 1 further comprising an electrical connection portion whereby at least one other transportable multi-configurable self-ballasted modular solar power unit is electrically connected therein.

7. The transportable multi-configurable self-ballasted modular solar power unit according to claim 1 wherein said solar module frame is attached at a selected angle with respect to said support frame.

8. The transportable multi-configurable self-ballasted modular solar power unit according to claim 1 further comprising at least one anchoring means for securing at least one of said plurality of trailer jacks to a selected installation site.

9. The transportable multi-configurable self-ballasted modular solar power unit according to claim 8 wherein said anchoring means is an earth anchor.

10. The transportable multi-configurable self-ballasted modular solar power unit according to claim 8 wherein said anchoring means is an earth nail.

11. The transportable multi-configurable self-ballasted modular solar power unit according to claim 1 further comprising a powered trailer jack means for adjusting said plurality of trailer jacks.

12. The transportable multi-configurable self-ballasted modular solar power unit according to claim 11 wherein said powered trailer jack means for adjusting said plurality of trailer jacks is a power wrench.

13. The transportable multi-configurable self-ballasted modular solar power unit according to claim 3 further comprising a powered means for adjusting said solar module frame to said selected angle.

14. The transportable multi-configurable self-ballasted modular solar power unit according to claim 13 wherein said powered means is a servo controlled support arm whereby said support arm can raise or lower said solar module frame when activated.

15. A method of installing a transportable multi-configurable self-ballasted modular solar power unit comprising the steps:
obtaining at least one transportable multi-configurable self-ballasted modular solar power unit;
raising a plurality of trailer jacks attached to said transportable multi-configurable self-ballasted modular solar power unit to a selected height;
positioning a trailer under said transportable multi-configurable self-ballasted modular solar power unit;
lowering said plurality of trailer jacks until said transportable multi-configurable self-ballasted modular solar power unit rests on said trailer; and
transporting said transportable multi-configurable self-ballasted modular solar power unit to a selected installation site;
lowering said plurality of trailer jacks until said transportable multi-configurable self-ballasted modular solar power unit is raised up and off said trailer.

16. The method of installing a transportable multi-configurable self-ballasted modular solar power unit according to claim 15 further comprising the step of individually adjusting said plurality of trailer jacks until said transportable multi-configurable self-ballasted modular solar power unit is level.
